(19) United States
(12) Patent Application Publication
(10) Pub. No.: US 2023/0409263 A1
(43) Pub. Date: Dec. 21, 2023

(54) Electronic Photo Album Assembly

(71) Applicant: Tanya Gordon, Royal Oak, MI (US)

(72) Inventor: Tanya Gordon, Royal Oak, MI (US)

(21) Appl. No.: 17/827,734

(22) Filed: May 29, 2022

(51) Int. Cl. G06F 3/14; G06F 3/02

(52) U.S. Cl. CPC G06F 3/14; G06F 3/0202

(57) ABSTRACT

An electronic photo album assembly for memorializing a deceased person includes a photo album that has a front cover, a back cover and a plurality of pages between the front cover and the back cover. A multimedia unit is integrated into the photo album and the multimedia unit is positioned on the back cover of the photo album. The multimedia unit includes an electronic display for displaying indicia comprising imagery that is previously downloaded into the multimedia unit. In this way the imagery displayed on the electronic display corresponds to the imagery on the pages associated with the deceased person.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to photo album devices and more particularly pertains to a new photo album device for memorializing a deceased person. The device includes a photo album that has a front cover, a back cover and a plurality of pages. The device includes a multimedia unit that is attached to the back cover. The multimedia unit includes an electronic display for displaying imagery to memorialize the deceased person and a speaker for emitting audible sounds to supplement the imagery displayed on the electronic display.

### (2) Description of Related Art Including Information Disclosed Under 37 CFR 1.97 and 1.98

The prior art relates to photo album devices including a variety of greeting card devices that each has an audio device for emitting pre-recorded audible sounds. The prior art discloses a rectilinear cremains container that includes photos of the decedent. The prior art discloses a variety of greeting card devices that have an electronic display for displaying imagery. The prior art discloses a variety of greeting card devices that has a digital recording device for recording an audible message.

### BRIEF SUMMARY OF THE INVENTION

An embodiment of the disclosure meets the needs presented above by generally comprising a photo album that has a front cover, a back cover and a plurality of pages between the front cover and the back cover. A multimedia unit is integrated into the photo album and the multimedia unit is positioned on the back cover of the photo album. The multimedia unit includes an electronic display for displaying indicia comprising imagery that is previously downloaded into the multimedia unit. In this way the imagery displayed on the electronic display corresponds to the imagery on the pages associated with the deceased person.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an electronic photo album assembly according to an embodiment of the disclosure.

FIG. 2 is a perspective view of an embodiment of the disclosure.

FIG. 3 is a right side view of an embodiment of the disclosure.

FIG. 4 is a schematic view of an embodiment of the disclosure.

### DETAILED DESCRIPTION OF THE INVENTION

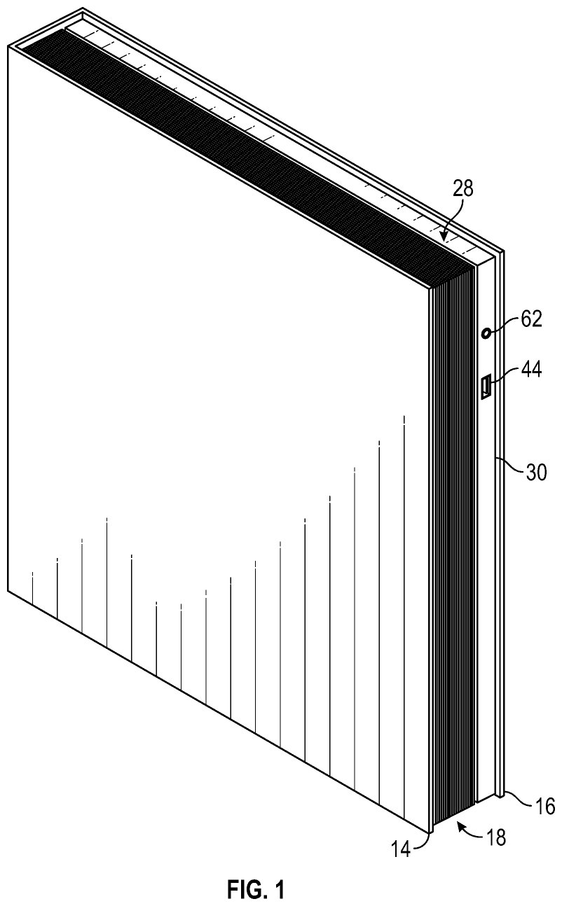

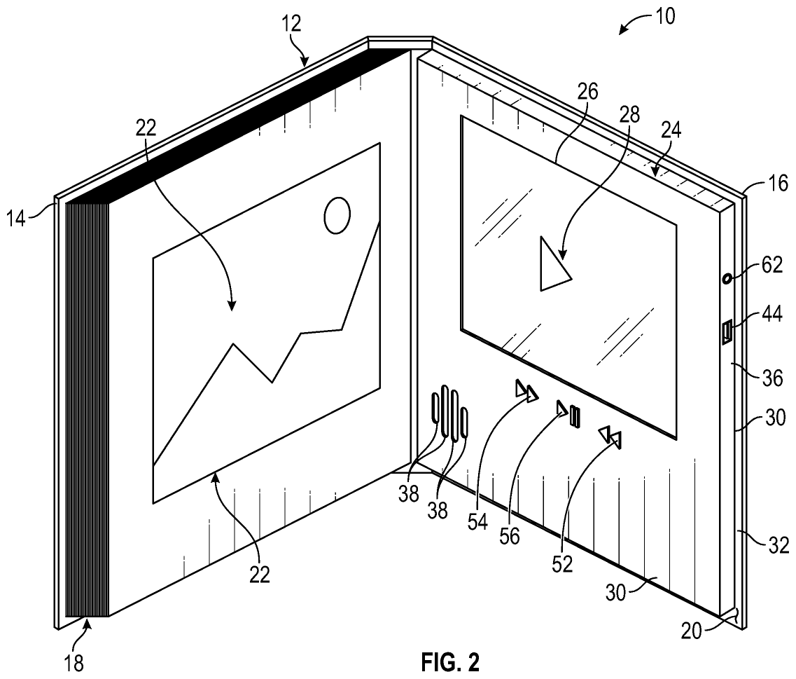

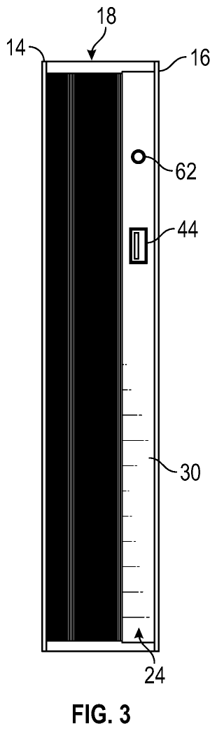

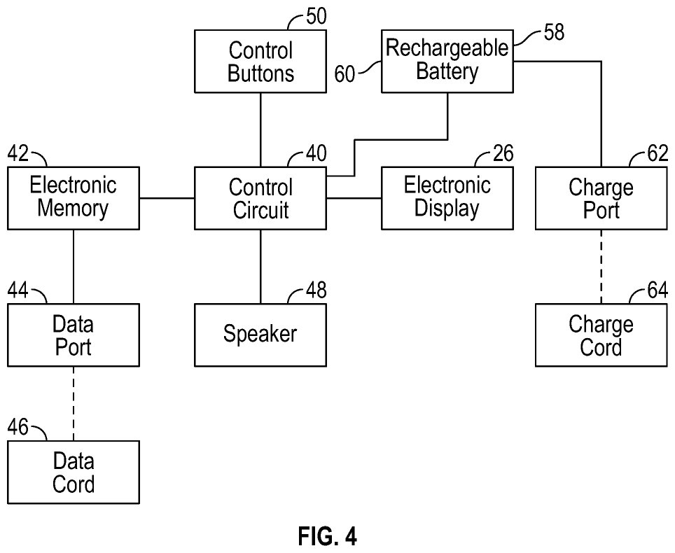

With reference now to the drawings, and in particular to FIGS. 1 through 4 thereof, a new photo album device embodying the principles and concepts of an embodiment of the disclosure and generally designated by the reference numeral 10 will be described.

As best illustrated in FIGS. 1 through 4, the electronic photo album assembly 10 generally comprises a photo album 12 that has a front cover 14, a back cover 16 and a plurality of pages 18 between the front cover 14 and the back cover 16. The back cover 16 has an inside surface 20 facing the plurality of pages 18 and each of the pages 18 has indicia 22 printed thereon comprising imagery associated with a deceased person. A multimedia unit 24 is integrated into the photo album 12 and the multimedia unit 24 is positioned on the back cover 16 of the photo album 12. The multimedia unit 24 includes an electronic display 26 for displaying indicia 28 comprising imagery that was previously downloaded into the multimedia unit 24. Furthermore, the imagery displayed on the electronic display 26 corresponds to the imagery on the pages 18 associated with the deceased person.

The multimedia unit 24 comprises a housing 30 that has a back side 32, a front side 34 and a first lateral side 36 extending between the front side 34 and the back side 32, and the back side 32 is bonded to the inside surface 20 of the back cover 16. The electronic display 26 is integrated into the front side 34 of the housing 30 such that the electronic display 26 is visible to a user. Additionally, the front side 34 has a plurality of speaker slots 38 each extending into the housing 30. The multimedia unit 24 includes a control circuit 40 that is positioned in the housing 30 and the control circuit 40 is electrically coupled to the electronic display 26.

The multimedia unit 24 includes an electronic memory 42 that is positioned in the housing 30 and the electronic memory 42 is electrically coupled to the control circuit 40. The multimedia unit 24 includes a data port 44 that is recessed into the first lateral side 36 of the housing 30 to receive a data cord 46 of a data storage device. The data port 44 is electrically coupled to the control circuit 40 thereby facilitating data comprising images and audio to be downloaded into the electronic memory 42. The multimedia unit 24 includes a speaker 48 that is integrated into the housing 30 and the speaker 48 is electrically coupled to the control circuit 40 thereby facilitating the speaker 48 to receive an audio signal comprising audio data downloaded into the electronic memory 42. Furthermore, the speaker 48 is aligned with the speaker slots 38 in the front side 34 of the housing 30 to emit audible sounds outwardly through the speaker slots 38.

The multimedia unit 24 includes a plurality of control buttons 50 that is each movably integrated into the front side 34 of the housing 30 such that each of the control buttons 50 can be manipulated by the user. Each of the control buttons 50 is electrically coupled to the control circuit 40 and the plurality of control buttons 50 controlling operational parameters of the control circuit 40. Furthermore, the plurality of control buttons 50 includes a rewind button 52, a fast forward button 54 and a play/pause button 56. In this way a video that is being played on the electronic display 26 can be fast forwarded, rewound, paused and played.

The multimedia unit 24 includes a power supply 58 that is integrated into the housing 30 and the power supply 58 is electrically coupled to the control circuit 40. The power supply 58 comprises a rechargeable battery 60 that is positioned in the housing 30 and the rechargeable battery 60 is electrically coupled to the control circuit 40. The power supply 58 includes a charge port 62 that is recessed into the first lateral side 36 of the housing 30 to receive a charge cord 64. The charge port 62 is electrically coupled to the control circuit 40 for charging the rechargeable battery 60.

In use, the pages 18 are printed with indicia 22 which memorialize a deceased person. Additionally, video data and audio data are downloaded into the electronic memory 42 from a data source, such as a laptop computer or other similar electronic device. In this way images and video clips can be played on the electronic display 26 that supplements the images on the pages 18. Additionally, the speaker 48 emits audio that is related to the video clips. In this way a family member can enjoy memories associated with the deceased person.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic photo album assembly for incorporating video footage into a photo album for a memorial for a decedent, said assembly comprising:
a photo album having a front cover, a back cover and a plurality of pages between said front cover and said back cover; and
a multimedia unit being integrated into said photo album, said multimedia unit being positioned on said back cover of said photo album, said multimedia unit including an electronic display for displaying indicia comprising imagery being previously downloaded into said multimedia unit wherein said imagery displayed on said electronic display corresponds to the imagery on said pages associated with the deceased person.

2. The assembly according to claim 1, wherein:
said back cover has an inside surface facing said plurality of pages, each of said pages having indicia being printed thereon comprising imagery associated with a deceased person; and
said multimedia unit comprises a housing having a back side, a front side and a first lateral side extending between said front side and said back side, said back side being bonded to said inside surface of said back cover, said electronic display being integrated into said front side of said housing wherein said electronic display is configured to be visible to a user, said front side having a plurality of speaker slots each extending into said housing.

3. The assembly according to claim 2, wherein said multimedia unit includes:
a control circuit being positioned in said housing, said control circuit being electrically coupled to said electronic display;
an electronic memory being positioned in said housing, said electronic memory being electrically coupled to said control circuit; and
a data port being recessed into said first lateral side of said housing wherein said data port is configured to receive a data cord of a data storage device, said data port being electrically coupled to said control circuit thereby facilitating data comprising images and audio to be downloaded into said electronic memory.

4. The assembly according to claim 3, wherein said multimedia unit includes a speaker being integrated into said housing, said speaker being electrically coupled to said control circuit thereby facilitating said speaker to receive an audio signal comprising audio data downloaded into said electronic memory, said speaker being aligned with said speaker slots in said front side of said housing wherein said speaker is configured to emit audible sounds outwardly through said speaker slots.

5. The assembly according to claim 3, wherein said multimedia unit includes a plurality of control buttons, each of said control buttons being movably integrated into said front side of said housing wherein each of said control buttons is configured to be manipulated by the user, each of said control buttons being electrically coupled to said control circuit, said plurality of control buttons controlling operational parameters of said control circuit, said plurality of control buttons including a rewind button, a fast forward button and a play/pause button.

6. The assembly according to claim 3, wherein said multimedia unit includes a power supply being integrated into said housing, said power supply being electrically coupled to said control circuit, said power supply comprising:
a rechargeable battery being positioned in said housing, said rechargeable battery being electrically coupled to said control circuit; and
a charge port being recessed into said first lateral side of said housing wherein said charge port is configured to receive a charge cord, said charge port being electrically coupled to said control circuit for charging said rechargeable battery.

7. An electronic photo album assembly for incorporating video footage into a photo album for a memorial for a decedent, said assembly comprising:
a photo album having a front cover, a back cover and a plurality of pages between said front cover and said back cover, said back cover having an inside surface facing said plurality of pages, each of said pages having indicia being printed thereon comprising imagery associated with a deceased person; and
a multimedia unit being integrated into said photo album, said multimedia unit being positioned on said back cover of said photo album, said multimedia unit including an electronic display for displaying indicia comprising imagery being previously downloaded into said multimedia unit wherein said imagery displayed on said electronic display corresponds to the imagery on said pages associated with the deceased person, said multimedia unit comprising:
a housing having a back side, a front side and a first lateral side extending between said front side and said back side, said back side being bonded to said inside surface of said back cover, said electronic display being integrated into said front side of said housing wherein said electronic display is configured to be visible to a user, said front side having a plurality of speaker slots each extending into said housing;
a control circuit being positioned in said housing, said control circuit being electrically coupled to said electronic display;
an electronic memory being positioned in said housing, said electronic memory being electrically coupled to said control circuit;
a data port being recessed into said first lateral side of said housing wherein said data port is configured to receive a data cord of a data storage device, said data port being electrically coupled to said control circuit thereby facilitating data comprising images and audio to be downloaded into said electronic memory;
a speaker being integrated into said housing, said speaker being electrically coupled to said control circuit thereby facilitating said speaker to receive an audio signal comprising audio data downloaded into said electronic memory, said speaker being aligned with said speaker slots in said front side of said housing wherein said speaker is configured to emit audible sounds outwardly through said speaker slots;
a plurality of control buttons, each of said control buttons being movably integrated into said front side of said housing wherein each of said control buttons is configured to be manipulated by the user, each of said control buttons being electrically coupled to said control circuit, said plurality of control buttons controlling operational parameters of said control circuit, said plurality of control buttons including a rewind button, a fast forward button and a play/pause button; and
a power supply being integrated into said housing, said power supply being electrically coupled to said control circuit, said power supply comprising:
a rechargeable battery being positioned in said housing, said rechargeable battery being electrically coupled to said control circuit; and
a charge port being recessed into said first lateral side of said housing wherein said charge port is configured to receive a charge cord, said charge port being electrically coupled to said control circuit for charging said rechargeable battery.
